(19) United States
(12) Patent Application Publication
(10) Pub. No.: US 2012/0308697 A1
(43) Pub. Date: Dec. 6, 2012

(54) SORGHUM TOPPING

(75) Inventor: Robert Harris, Englewood, NJ (US)

(73) Assignee: NEW INDUSTRIES, Englewood, NJ (US)

(21) Appl. No.: 13/551,319

(22) Filed: Jul. 17, 2012

Related U.S. Application Data
(63) Continuation-in-part of application No. 13/150,907, filed on Jun. 1, 2011.

(51) Int. Cl. A23L 1/30

(52) U.S. Cl. 426/289

(57) ABSTRACT

The present invention is related to processes for importing an improved anti-oxidant content with high ORAC values to a food product. Milled high tannin sorghum grain may be ground into flour and mixed with spices and herbs, which is then used as a topping on the food product of choice.

### TECHNICAL FIELD

Certain varieties of sorghum contain proanthocyanidins (commonly referred to as tannins or more strictly-speaking condensed tannins) in the seed coat layer beneath the pericarp (commonly referred to as the testa layer) of the grain. These varieties are variously referred to as: tannin, high-tannin, brown, bird-proof, bird-resistant, or bitter sorghums. Varieties of sorghum not containing tannins are various referred to as: non-tannin, low-tannin, condensed tannin-free, or sweet sorghums.

The present invention is related to processes for the manufacture of a food product having an improved antioxidant content and the product thereof.

The object of the present invention a method is to manufacture a food product having an improved antioxidant content and the product thereof.

### BACKGROUND OF THE INVENTION

Sorghum is primarily grown as animal feed in the US. Sorghum and rice are used generally for this purpose. Sorghum is a crop that lends itself to cultivation even in arid soils since it requires less moisture than most other crops and is especially appropriate in the plains, western and other arid areas of the United States. The creation of 100% bran of this grain has several benefits—namely, the ability to increase essential dietary fiber and high ORAC antioxidants to a variety of consumer diets.

Nutritionists and health professionals recommend eating whole grains, natural fiber, vegetables, fruits and low fat dairy products. Whole grains give one some natural fiber and important nutrients, while fruits and vegetables also provide critical fiber with a whole variety of antioxidants which are believed to help maintain good health, combat inflammation, neutralize damaging free radicals in our bodies and make other essential contributions to well being.

One benefit of the subject invention is thus to have a cereal product, primarily a sorghum flour, for use as a topping, having a high content of antioxidant. This includes use on such foods as beverages, soups, gravies, meat dishes, pasta dishes, eggs, salads, etc. and is achieved by the consumer directly by utilizing an additive of 100% high tannin sorghum bran in fine powdered from that the consumer may add at will to a variety of foods, either unique ethnic foods or ordinary foods to boost fiber and antioxidant values (ORAC) to virtually any diet. This is especially useful for the lower income groups who cannot afford to purchase adequate amounts of fresh fruit, vegetables and whole grains—thus, enabling all income groups to combat obesity, diabetes, heart disease and cancer by simply adding high tannin sorghum bran to the ordinary foods they consume and making this product available at moderate cost in supermarkets throughout the world.

High tannin sorghum is that sorghum with a high tannin content. Plants containing tannin may be differentiated into three categories; low tannin plants having less than 12% tannin content; average tannin plants having 12-20% tannin content; and high tannin plants having more than 20% tannin. In addition, there are no-tannin plants. For the purpose of this invention the term “high tannin sorghum” refers to that sorghum having a sorghum content of over 20%.

A measure of the antioxidant capacity of foodstuffs is its Oxygen Radical Absorbance Capacity (ORAC) measured in μmol of Trolox Equivalents per 100 grams (μmol TE/100 g). The correlation between the high antioxidant capacity of fruits and vegetables, and the positive impact of diets high in fruits and vegetables, in part due to the high antioxidant capacity of fruits and vegetables, is believed to play an important role in free radical theory of aging. High tannin sorghum bran generally is known to have up to 240000 μmol TE/100 g, while whole grain high tannin sorghum generally has from 20000 μmol TE/100 g up to 45000 μmol TE/100 g. Some strains of high tannin sorghum bran may have significantly less ORAC values, such as 36000 μmol TE/100 g.

Sorghum is also gluten free in contrast to other grains such as wheat or oats. Fiber is also present in sorghum bran and sorghum whole grain. Fiber, antioxidants and lack of gluten, combined with sorghum's relatively bland taste, make sorghum desirable for use on consumer foods, such as breakfast cereal, sandwiches, pancakes and others. Further, when high tannin sorghum is used in such consumer foods, the antioxidant activity is increased commensurate with the increase of the ORAC values.

### SUMMARY OF THE INVENTION

In the practice of the subject invention, the high tannin sorghum grain is milled and the bran is separated conventionally, unless whole grain sorghum is desired. The milled grain may then be ground into flour and mixed with another food stuff having a high antioxidant content, which is then used to make the food product topping desired.

Particularly high ORAC values result from the use of a specific type of sorghum that contains high levels of tannin. The high tannin sorghum variety also aids in weight loss. Thus the high tannin level sorghum is milled to a desired mesh size and, when used as a topping in conjunction with spices, herbs and other select high antioxidant foods for other food products, can yield a different texture and taste. Further there is then an added content of high tannin sorghum bran and, when using whole grain, a high tannin sorghum content. Topping food products with high tannin sorghum in combination with herbs and/or spices causes a dramatic increase in the fiber and ORAC levels of these food products and ingestion of such food products by a mammal then causes a concomitant increase in the antioxidant level within the mammal.

### DETAILED DESCRIPTION OF THE PRESENT INVENTION

High tannin sorghum grain is utilized to provide a high antioxidant topping with high ORAC values. The sorghum can be used as whole grain, and is milled and ground accordingly. In order to achieve maximum antioxidant content, the grain first goes through a decortification process. The entire grain, including the bran, is utilized. In the alternative, just the bran may be used. The grain or bran is first cooked at 250° F. for 45-60 minutes, formed into a pellet and then dried at 200° F. for 15 minutes. In this stage one drying, the high tannin sorghum pellet is reduced to a moisture content of 24% to 34%. The high tannin sorghum pellet is then tempered for 20 minutes and sent to the roll mills where they are pinched between two rolls to form a flake. The high tannin flake then goes to a second stage of drying at 350-375° F. for one minute. To make a high tannin flour, the high tannin flakes may be comminuted to a desired particle size, such as 10-100 mesh (Tyler) fiber, preferably 10-30 mesh (Tyler). This results in bran flour with a high ORAC value, about 20,000 to 40,000 μmol TE/100 g. Depending on the mixture combination percentages of bran and whole grain, the mixture of bran and whole grain can result in a topping having an ORAC value of 5000 to 35000 μmol TE/100 g.

The high tannin sorghum flake as flour may then be sprinkled onto various foodstuffs, such as bread, pancakes soups, beverages, gravies, meat dishes, eggs, salads, waffles, pasta, crackers, muffins and fruit as desired. It is suggested that two tablespoons of sorghum flour be sprinkled onto a food product of choice to provide increased supplementation of the ORAC values and fiber content of that food product.

The high tannin sorghum flour may be mixed with other food products high in antioxidant capacity and ORAC value. Ingredients such as spices, herbs, cheese, salt and pepper may be added to high tannin sorghum grain to increase antioxidant content (as measured by ORAC) and fiber. Other examples include wheat germ, onion, paprika, cinnamon, oregano, parsley and clove. When mixed with other high antioxidant foods, the ORAC value of the resultant topping can be from 2,000 to 35,000 μmol TE/100 g, dependent primarily on taste and texture considerations and the resulting percentage of each of the ingredients. Thus one can tailor the properties of the topping, i.e. for taste, texture, or ORAC value by mixing the appropriate relative amounts of high tannin sorghum grains (whole grain or bran), spices and herbs or the other additives as delineated above.

Having thus described several aspects of at least one embodiment of this invention, it is to be appreciated various alterations, modifications and improvements will readily occur to those skilled in the art. Such alterations, modifications and improvements are intended to be part of this disclosure, and are intended to be within the spirit and scope of the invention. Accordingly, the foregoing description and drawings are by way of example only.

What is claimed is:

1. A method of increasing anti-oxidant levels in a food product, comprising:
making a flour mixture from high tannin sorghum grain mixing the flour with a foodstuff selected from the group consisting of spices, herbs and cheese to form a flour mixture and spreading the flour mixture over the food product as a topping.

2. The method of claim 1 wherein the flour is 10-100 mesh.

3. The method of claim 1 wherein the flour is 10-30 mesh.

4. The method of claim 1 wherein the food product is selected from the group consisting of baked goods, sauces, pasta, cereals, beverages, soups, gravies, eggs and salads.

5. The method of claim 1 wherein the food product is breakfast cereal, bread, pancake mix waffle mix, pasta, pasta sauce, crackers, muffins, fudge sauce and brownies.

6. The method of claim 1 wherein the high tannin sorghum is whole grain or bran.

7. The method of claim 1 wherein the flour mixture has an ORAC value of from 5000 to 35000 μmol TE/100 g.
